(19) United States
(12) Patent Application Publication
(10) Pub. No.: US 2026/0261235 A1
(43) Pub. Date: Sep. 3, 2026

(54) SELF-CLEANING SOLAR PANEL ASSEMBLY

(71) Applicant: SEG Solar Inc., Houston, TX (US)

(72) Inventors: Tao Zou, Changzhou City (CN); Jian Zhou, Taizhou City (CN); Jun Zhuge, Cypress, TX (US)

(73) Assignee: SEG Solar Inc., Houston, TX (US)

(21) Appl. No.: 19/554,243

(22) Filed: Mar. 2, 2026

Related U.S. Application Data
(60) Provisional application No. 63/766,069, filed on Mar. 3, 2025.

(51) Int. Cl. H02S 40/10; H02S 30/10

(52) U.S. Cl. CPC H02S 40/10; H02S 30/10

(57) ABSTRACT

A solar module includes a photovoltaic panel and a frame structure for retaining the photovoltaic panel on at least two sides. The frame structure has an elongated body on each of the sides, and the elongated body has a central segment having a first substantially consistent cross-section and end segments each having a second cross-section distinct from the first substantially consistent cross-section. The first substantially consistent cross section includes a substantially horizontal section for engaging a back surface of the photovoltaic panel, and a substantially vertical section extending from the substantially horizontal section in a substantially perpendicular direction for engaging a side surface of the photovoltaic panel. The second cross-section includes the substantially horizontal section for engaging the back surface of the photovoltaic panel but not the substantially vertical section.

### CROSS-REFERENCE TO RELATED APPLICATION

This application takes priority from U.S. Provisional Patent Application No. 63/766,069 filed March 3, 2025, the contents of which are incorporated by reference herein in their entirety.

### FIELD OF THE INVENTION

The invention relates to framing and mounting assemblies for solar photovoltaic panels.

### BACKGROUND

At present, the mainstream design of photovoltaic module frames encloses an edge of a photovoltaic panel, or PV panel, on three sides. Accordingly, when a solar module is installed, an edge of the PV panel is located within a channel formed by the three sides of the frame. This includes an “A-side,” or front side, which rests on a front surface of the PV panel and makes the frame higher than the PV panel, typically formed from laminated glass.

The PV panel is then located within a slot of the frame formed by the “A-side,” a “B-side” forming a sidewall, and a “C-side” forming a back of the slot on which a back surface of the PV panel can rest. The A-side may rest on the PV panel or may be positioned adjacent the PV panel and may then extend higher than the panel by, e.g., 2-3mm, thereby causes partial shielding.

During long-term operation of the module, a large amount of dust and water stains may form on the surface of the PV panel where the A-side of the frame meets the PV panel, thereby causing local shadows. This results in power loss and "hot spot" phenomenon. When the dust and water stains cannot be cleaned and eliminated over a long period of time, the hot spot effect increases, and upon reaching a failure level, some cells of the module turn from power generation to power consumption. In severe cases, it will cause a fire or other PV panel failure, resulting in the scrapping of the entire solar cell module, and in some cases, causing the roof and other buildings to burn down.

Existing solutions take several forms, all of which have significant flaws. Some existing products eliminate the A-side entirely, which can result in damage during transportation and handling, and which also drastically reduces the capacity of the frame taken as a whole.

In some existing products, one side of the frame may be removed entirely, such that fluid can drain on that side. However, this approach limits the orientation and installation types usable by the solar module.

In some existing products, ends of frame members are removed entirely and replaced with brackets, or existing brackets are exposed. As such, the portion of the frame that supports the PV panel at the corners is removed, such that fluid can drain at those corners. However, this results in the corners of the PV panel no longer resting on the frames such that they are exposed. As such, this design causes the load-bearing of the four corners of the module to rely solely on the corner brackets without any corresponding bearing surface, thereby resulting in poor load performance.

### SUMMARY

In some embodiments, a solar module is provided. The solar module includes a photovoltaic panel and a frame structure for retaining the photovoltaic panel on at least two sides.

The frame structure has an elongated body on each of the at least two sides, and the elongated body has a central segment having a first substantially consistent cross-section and end segments each having a second cross-section distinct from the first substantially consistent cross-section. The first substantially consistent cross section includes a substantially horizontal section for engaging a back surface of the photovoltaic panel, and a substantially vertical section extending from the substantially horizontal section in a substantially perpendicular direction for engaging a side surface of the photovoltaic panel.

The second cross-section includes the substantially horizontal section for engaging the back surface of the photovoltaic panel but not the substantially vertical section.

In some embodiments, the first substantially consistent cross-section also includes a front section extending from the substantially vertical section in a substantially perpendicular direction and substantially parallel to the substantially horizontal surface. The front section engages a front surface of the photovoltaic panel.

In some such embodiments, the first substantially consistent cross-section and the second cross-section each include a base section, where the substantially horizontal section defines a top boundary of the base section, and where a foot of the frame structure defines a bottom boundary of the base section such that the base section supports the photovoltaic panel at the substantially horizontal section and spaces the photovoltaic panel apart from a mounting surface. In some such embodiments, the base section is an internal hollow section.

In some embodiments having a front section, the front section includes a groove or pocket for retaining adhesive.

In some embodiments having a front section, the end segments are substantially consistent, and are therefore an extension of the first substantially consistent cross-section without the substantially vertical section or the front section.

In some embodiments having a front section, the frame structure includes the elongated body on four sides of the photovoltaic panel.

In some such embodiments, each elongated body meets an adjacent elongated body at an angle, and the end segment comprising the second cross-section extends from an outer end adjacent an outer boundary of the photovoltaic panel to an inner end located under the photovoltaic panel. A lateral end of the end segment of each elongated body is angled such that the inner end has a first length and is truncated relative to a second length of the outer end.

In some such embodiments, at any location between the outer end and the inner end, the second cross-section of the end segment extends laterally from the first substantially consistent cross-section of the central segment until terminating at its truncated length.

In some embodiments having angled ends, the angle is 45 degrees.

Also provided is a solar module frame. Such a frame includes a frame structure for retaining a photovoltaic panel on at least two sides. The frame structure includes an elongated body on each of the two sides, and the elongated body has a central segment having a first substantially consistent cross-section and end segments each having a second cross-section distinct from the first substantially consistent cross-section.

The first substantially consistent cross section includes a substantially horizontal section for engaging a back surface of the photovoltaic panel during use, and a substantially vertical section extending from the substantially horizontal section in a substantially perpendicular direction. The second cross-section includes the substantially horizontal section but not the substantially vertical section.

In some such embodiments, the first substantially consistent cross-section includes a front section extending from the vertical section in a substantially perpendicular direction and substantially parallel to the substantially horizontal surface.

In some such embodiments, the first substantially consistent cross-section and the second cross-section each have a base section, where the substantially horizontal section defines a top boundary of the base section, and where a foot of the frame structure defines a bottom boundary of the base section such that during use, the base section supports the photovoltaic panel at the substantially horizontal section and spaces the photovoltaic panel apart from a mounting surface. In some such embodiments, the base section is an internal hollow section.

In some embodiments having a front section, the front section includes a groove or pocket for retaining adhesive.

In some embodiments having a front section, the end segments are substantially consistent, and are therefore an extension of the first substantially consistent cross-section without the substantially vertical section or the front section.

In some embodiments, the frame structure comprises four elongated bodies defining the frame.

In some such embodiments, each elongated body meets an adjacent elongated body at an angle, and end segments comprising the second cross-section extend from an outer end adjacent an outer boundary of the photovoltaic panel to an inner end located under the photovoltaic panel, and a lateral end of each end segment of each elongated body is angled such that the inner end has a first length and is truncated relative to a second length of the outer end.

In some such embodiments, at any location between the outer end and the inner end, the second cross-section extends laterally from the first substantially consistent cross-section until terminating at its truncated length.

In some embodiments having angled ends, the angle is forty-five degrees.

### BRIEF DESCRIPTION OF THE DRAWINGS

FIG. 1 is a perspective view of a solar module in accordance with this disclosure.

FIG. 2 is a top view of the solar module of FIG. 1.

FIG. 3 is a detail perspective view of a portion of the solar module of claim 1.

FIG. 4 is a detail perspective view of a solar module frame for use in the solar module of FIG. 1.

FIG. 5 is a detail top view of the solar module frame of FIG. 4.

FIG. 6 is a side view of the solar module of FIG. 1.

FIG. 7 is a section view of the solar module of FIG. 1.

FIG. 8 is a perspective view of an elongated body of the solar module frame of FIG. 4.

FIG. 9 is a side view of the elongated body of FIG. 8.

FIG. 10 is a top view of the elongated body of FIG. 8.

FIG. 11 is a front view of the elongated body of FIG. 8.

FIG. 12 is a front shortened view of the elongated body of FIG. 8 in order to provide additional detail, with the wavy lines representing a discontinuity.

FIG. 13 is a cross-section of a central segment of the elongated body of FIG. 8 retaining the PV panel.

FIG. 14 is a cross-section of an end segment of the elongated body of FIG. 8 retaining the PV panel.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

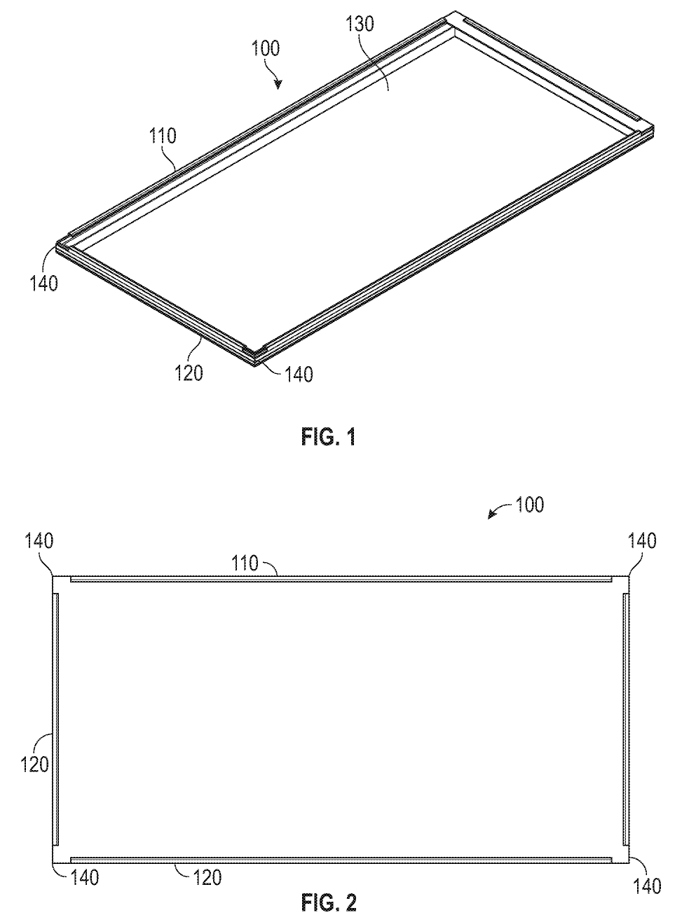

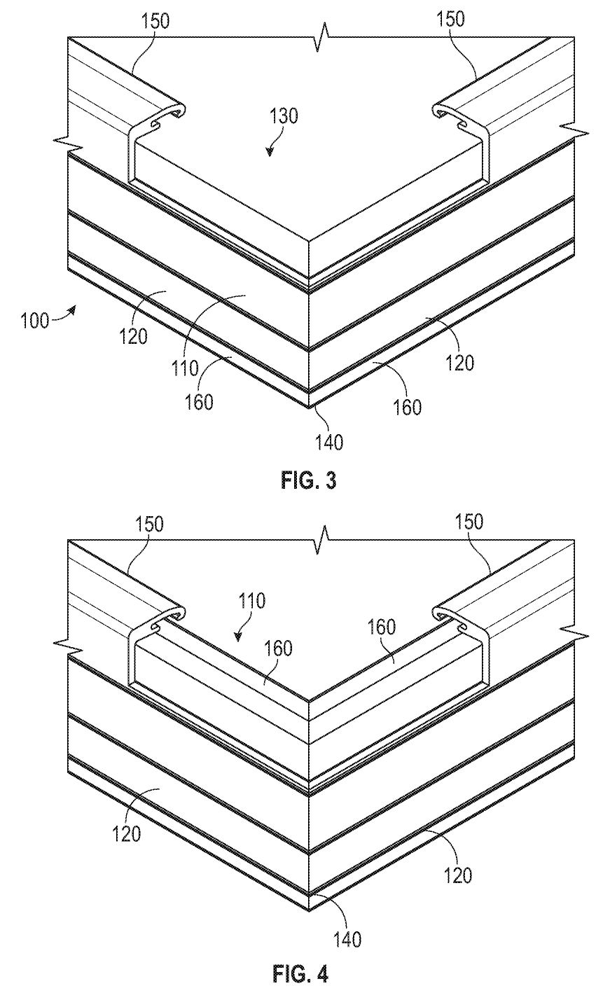

FIG. 1 is a perspective view of a solar module 100 in accordance with this disclosure. FIG. 2 is a top view of the solar module 100 of FIG. 1. FIG. 3 is a detail perspective view of a portion of the solar module 100 of claim 1.

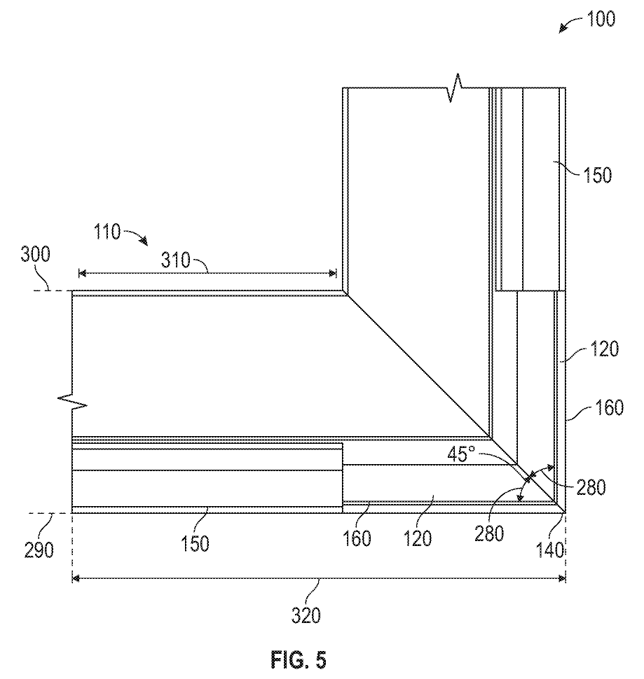

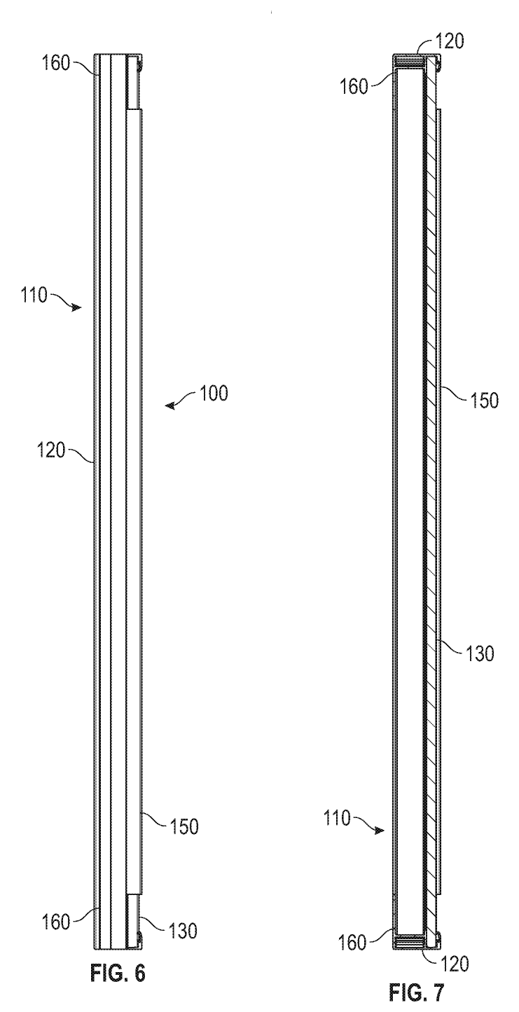

FIG. 4 is a detail perspective view of a solar module frame 110 for use in the solar module 100 of FIG. 1. FIG. 5 is a detail top view of the solar module frame 110 of FIG. 4. FIG. 6 is a side view of the solar module 100 of FIG. 1. FIG. 7 is a section view of the solar module 100 of FIG. 1.

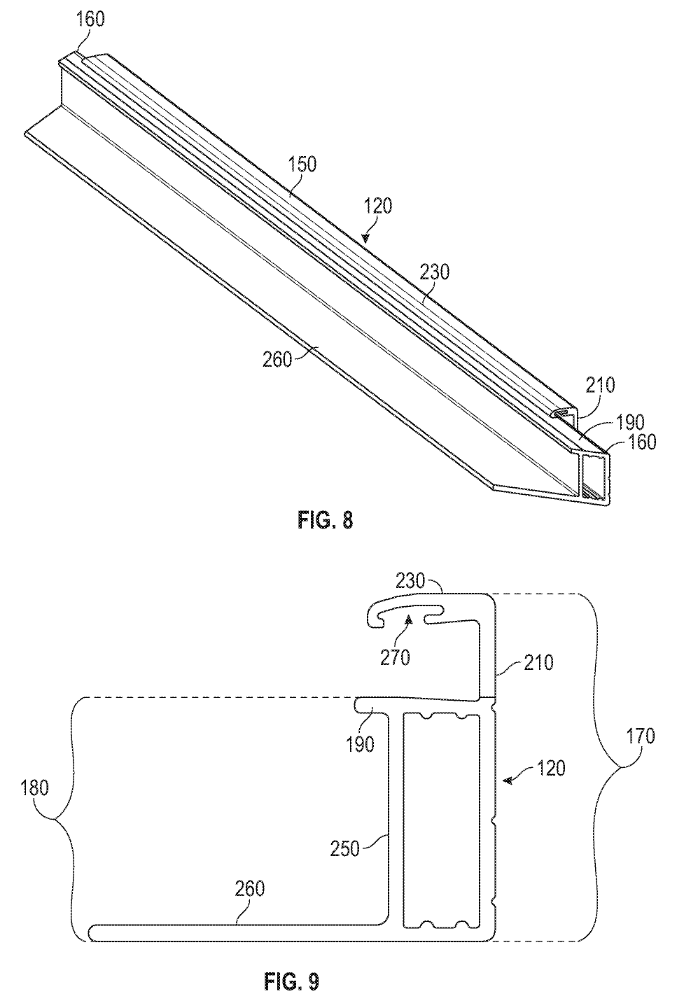

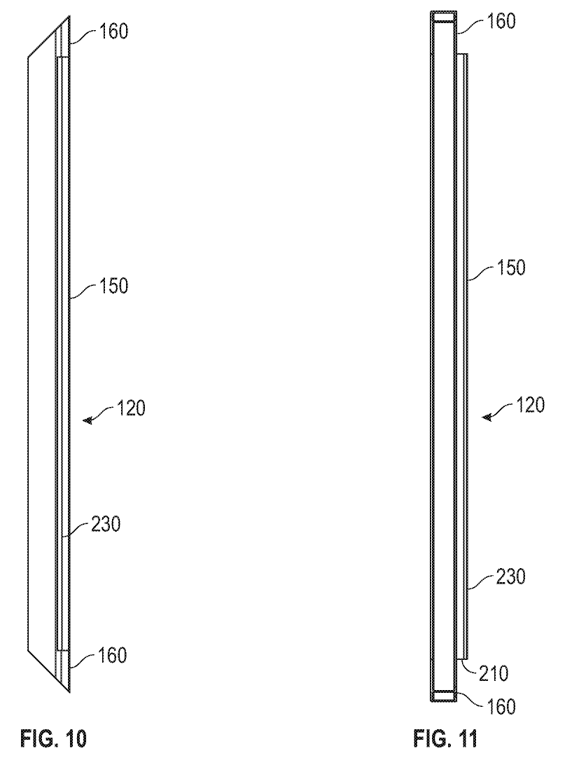

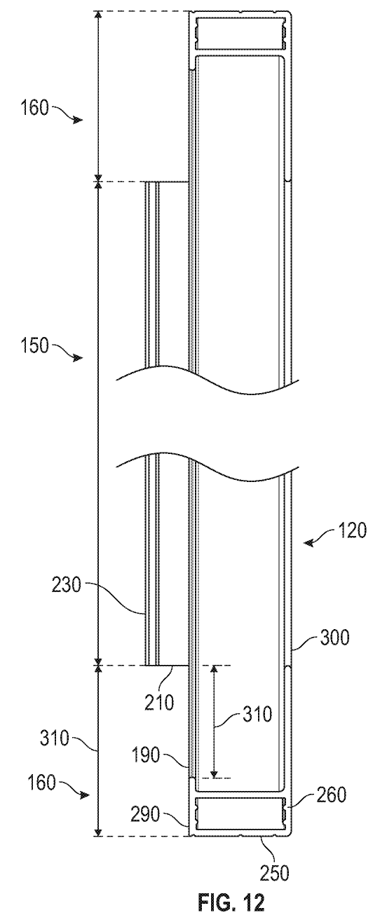

FIG. 8 is a perspective view of an elongated body 120 of the solar module frame 110 of FIG. 4. FIG. 9 is a side view of the elongated body 120 of FIG. 8. FIG. 10 is a top view of the elongated body 120 of FIG. 8. FIG. 11 is a front view of the elongated body 100 of FIG. 8. FIG. 12 is a front shortened view of the elongated body 100 of FIG. 8 in order to provide additional detail, with the wavy lines representing a discontinuity.

As shown, a solar module 100 has a photovoltaic (PV) panel 130 and a frame structure 110 for retaining the PV panel on at least two sides. As shown in FIG. 1, the PV panel 130 is typically rectangular, and the frame structure 110 would typically retain the PV panel 130 on all four sides. The PV panel 130 is a panel used to produce electricity from sunlight, and typically comprises a number of solar cells embedded in ro fixed between glass panels which may be laminated.

The frame structure 110 comprises an elongated body 120 on each side on which it retains the PV panel 130. Accordingly, where the frame structure 110 encloses and retains the PV panel 130 on all four sides, it would then comprise four elongated bodies 120. As discussed and shown below in reference to FIGS. 3-5, the elongated bodies 120 would then meet at corners 140 of the solar module 100.

Each elongated body 120 has a central segment 150 having a first substantially consistent cross-section and a plurality of end segments 160 each having a second cross-section distinct from the first substantially consistent-cross section. In a typical embodiment, each elongated body 120 would have an end segment 160 at each end of the central segment 150, such that the central segment is sandwiched between two end segments.

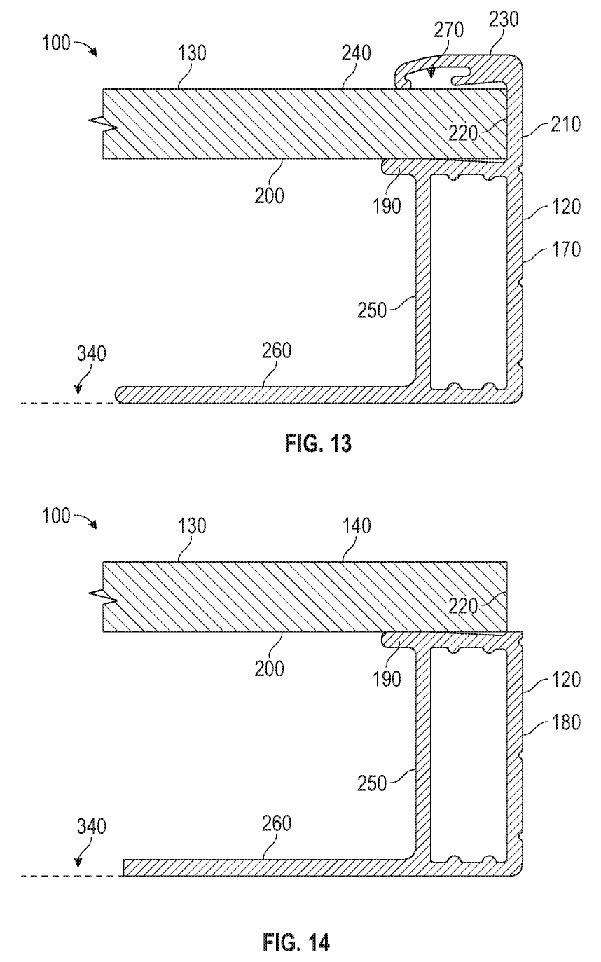

FIG. 13 is a cross-section 170 of a central segment 150 of the elongated body 120 of FIG. 8 retaining the PV panel 130. FIG. 14 is a cross-section 180 of an end segment 160 of the elongated body 120 of FIG. 8 retaining the PV panel 130.

The first substantially consistent cross-section 170 then comprises a substantially horizontal section 190 for engaging a back surface 200 of the PV panel 130. The first substantially consistent cross-section 170 also comprises a substantially vertical section 210 extending from the substantially horizontal section 190 in a substantially perpendicular direction. The substantially vertical section 210 is generally for engaging a side surface 220 of the PV panel 130.

The second cross-section 180 then comprises the substantially horizontal section 190 for engaging the back surface 200 of the PV panel 130, but not the substantially vertical section 210.

The first substantially consistent cross-section 170 may also include a front section 230 extending from the substantially vertical section 210 in a substantially perpendicular direction and substantially parallel to the substantially horizontal surface 190. The front section 230 then engages a front surface 240 of the PV panel 130. In some embodiments, the front section 230 includes a groove or pocket 270 for retaining adhesive. Accordingly, once assembled, the PV panel 130 may be bonded to the front section 230 using adhesive.

It will be understood that the term substantially in this disclosure is used to indicate approximate measurements or angles, such that the limitations are met even if surfaces are not fully horizontal or vertical, or are not parallel or perpendicular with mathematical precision. Further, certain components, such as the front section 230 shown in the figures, have curved boundaries, and therefore while approximations of a plane of the element may be perpendicular to the substantially vertical section 210 and parallel to the substantially horizontal section 190, such relationships may be based on approximations of the orientations of those components. However, such approximate relationships are within the bounds of the invention.

As shown, the substantially horizontal section 190 may be consistent in the context of each of the central segment 150 and the end segments 160, while the vertical section 210 and the front section 230 where present are not included in the end segments 160. Accordingly, any dust or liquid, or other dirt, may easy be drained or washed away by way of the corners 140 of the structure in view of the removed vertical and front sections 210, 230. However, by retaining a consistent horizontal section 190, the PV panel 130 continues to be supported, and therefore the load capacity of the frame 110 taken as a whole can be maintained.

As shown, the first substantially consistent cross-section cross section 170 and the second cross-section 180 may each further comprise a base section 250. The substantially horizontal section 190 may then define a top boundary of the base section 250 and a foot of the structure 260 may define a bottom boundary of the base section.

The base section 250 may then support the PV panel 130 at the substantially horizontal section 190 and may then space the PV panel 130 apart from a mounting surface 340. The base section 250 may be an internal hollow section, as shown.

In some embodiments, the end segments 160 and the corresponding cross-sections 180 are substantially consistent, and as such, they are an extension of the first substantially consistent cross section 170 without the substantially vertical section 210 or the front section 230.

In other embodiments, such as in the embodiment shown, each elongated body 120 meets an adjacent elongated body 120 at a corner 140 and is therefore formed or cut at and meets at an angle 280. In particular, the lateral ends of the end segments 160 terminate at the angle 280. The end segments 160 comprising the second cross-section 180 then extend from an outer end 290 adjacent an outer boundary of the PV panel 130 to an inner end 300 located under the PV panel 130. The lateral ends of the end segments 160 of each elongated body 120 are then angled such that the inner end 300 has a first length 310 and is truncated relative to a second length 320 of the outer end 290.

The inner 300 and outer ends 290 may be considered in terms of the end segments 160 taken alone or in the context of the elongated body 120 considered as a whole. As shown in FIG. 5, they may be considered in terms of any portion of the central segment 150 shown, as the central segment has a substantially consistent cross-section 170 and therefore the only difference in length between the inner 300 and outer ends 290 will be due to the end segment 160. Accordingly, the first length 310 and the second length 320 may be measured differently or may vary, but the second length 320 will always be shorted than the first length 310. As shown in FIG. 12, for example, if the second length 320 is measured at the horizontal section 190, it will be longer than if measured from the foot of the structure 260 but still shorter than the first length 310.

When viewed from a top, or front, of the solar module 100 or frame 110, as shown in FIG. 5, the lateral ends of the end segments 160 having the second cross-section 180 terminate at the angle 280 such that they can fit with and define a frame with adjacent elongated bodies 120. As such, for ease of manufacturing or assembly, the angle 280 may be approximately forty-five degrees. For example, the angle may be 45° ± .25°.

The angle 280 and corresponding end of the end segments 160 may extend from the inner end 300 to the outer end 290 and as such, any location along the end may have a different truncated length. Accordingly, at any location between the outer end 290 and the inner end 300, the second cross-section 180 of the end segment 160 extends laterally from the first substantially consistent cross-section 170 of the central segment 150 until terminating at its truncated length.

As shown, the end segments 160 defined by the second cross-section 180 may begin at the same location along the elongated body 120 at which the angle 280 begins. As such, when viewed from the top, or front, of the solar module 100 or frame 110, as shown in FIG. 5, the end segments 160 may appear as a 45-45-90 right triangle.

As shown in FIG. 9, all components of the second cross-section 180 may extend laterally from corresponding components of the first cross-section 170. Accordingly, while the vertical section 210 and the front section 230 may terminate at the transition from the central segment 150 to the end segment 160, the substantially horizontal section 190 of the end segments 160 may be the same section as that of the central segment 150. Similarly, the base section 250 of the end segments 160 may be the same as the base section of the central segment 150, and when viewed from the end, the hollow interior of the base section 250 may then be visible.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A solar module comprising:
a photovoltaic panel; and
a frame structure for retaining the photovoltaic panel on at least two sides,
wherein the frame structure comprises an elongated body on each of the at least two sides, wherein the elongated body has a central segment having a first substantially consistent cross-section and a plurality of end segments each having a second cross-section distinct from the first substantially consistent cross-section,
the first substantially consistent cross section comprising:
a substantially horizontal section for engaging a back surface of the photovoltaic panel, and
a substantially vertical section extending from the substantially horizontal section in a substantially perpendicular direction for engaging a side surface of the photovoltaic panel,
the second cross-section comprising the substantially horizontal section for engaging the back surface of the photovoltaic panel but not the substantially vertical section.

2. The solar module of claim 1 wherein the first substantially consistent cross-section further comprises a front section extending from the substantially vertical section in a substantially perpendicular direction and substantially parallel to the substantially horizontal surface, the front section engaging a front surface of the photovoltaic panel.

3. The solar module of claim 2 wherein the first substantially consistent cross-section and the second cross-section each comprise a base section, wherein the substantially horizontal section defines a top boundary of the base section, and wherein a foot of the frame structure defines a bottom boundary of the base section such that the base section supports the photovoltaic panel at the substantially horizontal section and spaces the photovoltaic panel apart from a mounting surface.

4. The solar module of claim 3 wherein the base section is an internal hollow section.

5. The solar module of claim 2 wherein the front section comprises a groove or pocket for retaining adhesive.

6. The solar module of claim 2 wherein the end segments are substantially consistent, and are therefore an extension of the first substantially consistent cross-section without the substantially vertical section or the front section.

7. The solar module of claim 2 wherein the frame structure comprises the elongated body on four sides of the photovoltaic panel.

8. The solar module of claim 7 wherein each elongated body meets an adjacent elongated body at an angle, and wherein the end segment comprising the second cross-section extends from an outer end adjacent an outer boundary of the photovoltaic panel to an inner end located under the photovoltaic panel, and wherein a lateral end of the end segment of each elongated body is angled such that the inner end has a first length and is truncated relative to a second length of the outer end.

9. The solar module of claim 8 wherein at any location between the outer end and the inner end, the second cross-section of the end segment extends laterally from the first substantially consistent cross-section of the central segment until terminating at its truncated length.

10. The solar module of claim 8 wherein the angle is forty-five degrees.

11. A solar module frame comprising:
a frame structure for retaining a photovoltaic panel on at least two sides,
wherein the frame structure comprises an elongated body on each of the at least two sides, wherein the elongated body has a central segment having a first substantially consistent cross-section and a plurality of end segments each having a second cross-section distinct from the first substantially consistent cross-section,
the first substantially consistent cross section comprising:
a substantially horizontal section for engaging a back surface of the photovoltaic panel during use, and
a substantially vertical section extending from the substantially horizontal section in a substantially perpendicular direction,
the second cross-section comprising the substantially horizontal section but not the substantially vertical section.

12. The solar module frame of claim 11 wherein the first substantially consistent cross-section further comprises a front section extending from the vertical section in a substantially perpendicular direction and substantially parallel to the substantially horizontal surface.

13. The solar module frame of claim 12 wherein the first substantially consistent cross-section and the second cross-section each comprise a base section, wherein the substantially horizontal section defines a top boundary of the base section, and wherein a foot of the frame structure defines a bottom boundary of the base section such that during use, the base section supports the photovoltaic panel at the substantially horizontal section and spaces the photovoltaic panel apart from a mounting surface.

14. The solar module frame of claim 13 wherein the base section is an internal hollow section.

15. The solar module frame of claim 12 wherein the front section comprises a groove or pocket for retaining adhesive.

16. The solar module frame of claim 12 wherein the end segments are substantially consistent, and are therefore an extension of the first substantially consistent cross-section without the substantially vertical section or the front section.

17. The solar module frame of claim 11 wherein the frame structure comprises four elongated bodies defining the frame.

18. The solar module frame of claim 17 wherein each elongated body meets an adjacent elongated body at an angle, and wherein end segments comprising the second cross-section extend from an outer end adjacent an outer boundary of the photovoltaic panel to an inner end located under the photovoltaic panel, and wherein a lateral end of each end segment of each elongated body is angled such that the inner end has a first length and is truncated relative to a second length of the outer end.

19. The solar module frame of claim 18 wherein at any location between the outer end and the inner end, the second cross-section extends laterally from the first substantially consistent cross-section until terminating at its truncated length.

20. The solar module frame of claim 18 wherein the angle is forty-five degrees.
